(19) United States
(12) Patent Application Publication
(10) Pub. No.: US 2011/0276784 A1
(43) Pub. Date: Nov. 10, 2011

(54) HIERARCHICAL MULTITHREADED PROCESSING

(75) Inventors: Evan Gewirtz, San Ramon, CA (US); Robert Hathaway, Sunnyvale, CA (US); Stephan Meier, Sunnyvale, CA (US); Edward Ho, San Jose, CA (US)

(73) Assignee: TELEFONAKTIEBOLAGET L M ERICSSON (PUBL), Stockholm (SE)

(21) Appl. No.: 12/777,087

(22) Filed: May 10, 2010

(51) Int. Cl. G06F 9/312; G06F 9/30

(52) U.S. Cl. 712/205; 712/214; 712/216; 712/E09.028; 712/E09.033

(57) ABSTRACT

In one embodiment, a current candidate thread is selected from each of multiple first groups of threads using a low granularity selection scheme, where each of the first groups includes multiple threads and first groups are mutually exclusive. A second group of threads is formed comprising the current candidate thread selected from each of the first groups of threads. A current winning thread is selected from the second group of threads using a high granularity selection scheme. An instruction is fetched from a memory based on a fetch address for a next instruction of the current winning thread. The instruction is then dispatched to one of the execution units for execution, whereby execution stalls of the execution units are reduced by fetching instructions based on the low granularity and high granularity selection schemes.

### FIELD OF THE INVENTION

Embodiments of the invention relate generally to the field of multiprocessing; and more particularly, to hierarchical multithreaded processing.

### BACKGROUND

Many microprocessors employ multi-threading techniques to exploit thread-level parallelism. These techniques can improve the efficiency of a microprocessor that is running parallel applications by taking advantage of resource sharing whenever there are stall conditions in each individual thread to provide execution bandwidth to the other threads. This allows a multi-threaded processor to have an advantage in efficiency (i.e. performance per unit of hardware cost) over a simple multi-processor approach. There are two general classes of multi-threaded processing techniques. The first technique is to use some dedicated hardware resources for each thread which arbitrate constantly and with high temporal granularity for some other shared resources. The second technique uses primarily shared hardware resources and arbitrates between the threads for use of those resources by switching active threads whenever certain events are detected. These events are usually large latency events such as cache misses, or long floating-point operations. When one of these events is detected, the arbiter chooses a new thread to use the shared resources until another such event is detected.

The high-granularity arbitration technique generally provides a better performance than the low-granularity technique because it is able to take advantage of very shorter conditions in one thread to provide execution bandwidth to another thread and the thread switching can be done with little or no switching penalty for a limited number of threads. However, this option does not scale easily to large numbers of threads for two reasons. First, since the ratio of shared resources to dedicated resources is high, there is not as much performance efficiency to be gained from the multi-threading approach relative a multi-processor solution. It is also difficult to efficiently arbitrate among large numbers of threads in this manner since the arbitration needs to be performed very quickly. If the arbitration is not fast enough, then thread-switching penalty will be introduced, which will have a negative impact on performance. Thread switching penalty is additional time that the shared resources cannot be used due to the overhead required to switch from executing one thread to another. The low-granularity arbitration technique is generally easier to implement, but it is difficult to avoid introducing significant switching penalties when the thread-switch events are detected and the thread switching is performed. This makes it difficult to take advantage of short stall conditions in the active thread to provide bandwidth to the other threads. This significantly reduces the efficiency gains that can be achieved using this technique.

### SUMMARY OF THE DESCRIPTION

In one aspect of the invention, a current candidate thread is selected from each of multiple first groups of threads using a low granularity selection scheme, where each of the first groups includes multiple threads and first groups are mutually exclusive. A second group of threads is formed comprising the current candidate thread selected from each of the first groups of threads. A current winning thread is selected from the second group of threads using a high granularity selection scheme. An instruction is fetched from a memory based on a fetch address for a next instruction of the current winning thread. The instruction is then dispatched to one of the execution units for execution, whereby execution stalls of the execution units are reduced by fetching instructions based on the low granularity and high granularity selection schemes.

Other features of the present invention will be apparent from the accompanying drawings and from the detailed description which follows.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating processor pipelines according to one embodiment of the invention.

FIG. 2 is a block diagram illustrating a fetch pipeline stage of a processor according to one embodiment.

FIG. 3 is a block diagram illustrating an execution pipeline stage of a processor according to one embodiment of the invention.

FIG. 4 is a flow diagram illustrating a method for fetching instructions according to one embodiment of the invention.

FIGS. 5A and 5B are flow diagrams illustrating a method for fetching instructions according to certain embodiments of the invention.

FIG. 6 is a block diagram illustrating a network element according to one embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

According to some embodiments, two multi-threading arbitration techniques are utilized to implement a microprocessor with a large number of threads that can also take advantage of most or all stall conditions in the individual threads to give execution bandwidth to the other threads, while still maintaining high performance for a given hardware cost. This is achieved by selectively using the one of the two techniques in different stages of the processor pipeline so that the advantages of both techniques are achieved, while avoiding both the excessive cost of high-granularity threading and the high switching penalties of low granularity event based threading. Additionally, the high granularity technique allows the critical shared resources to be used by other threads during whatever switching penalties are incurred when switching events are detected by the low granularity mechanism. This combination of mechanisms also allows for optimization based on the instruction mix of the threads' workloads and the memory latency seen in the rest of the system.

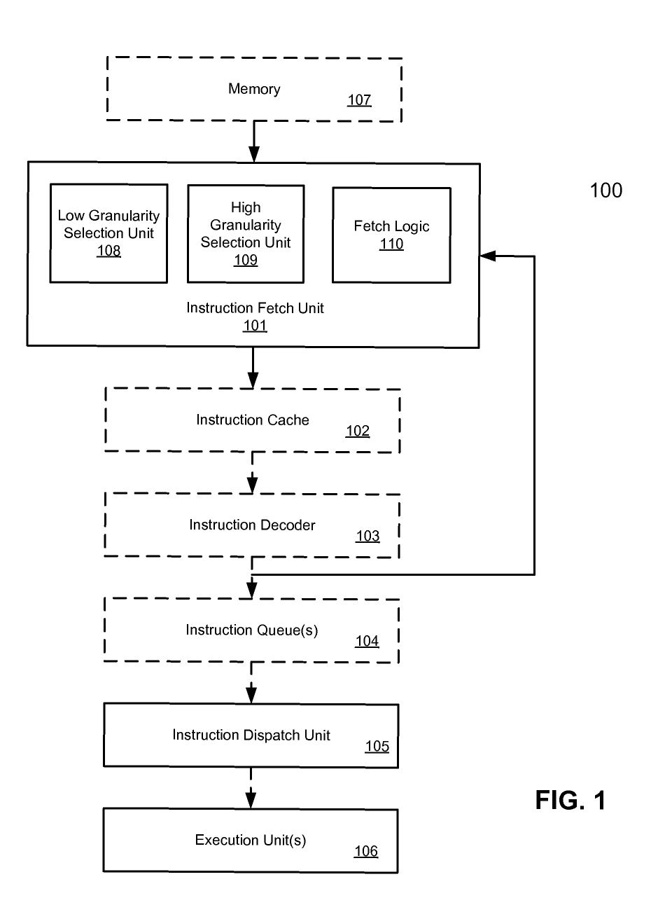

FIG. 1 is a block diagram illustrating processor pipelines according to one embodiment of the invention. Referring to FIG. 1, processor 100 includes instruction fetch unit 101, instruction cache 102, instruction decoder 103, one or more instruction queues 104, instruction dispatch unit 105, and one or more execution units 106. Instruction fetch unit 101 is configured to fetch a next instruction or group of instructions for one or more threads from memory 107 and to store the fetched instructions in instruction cache 102. Instruction decoder 103 is configured to decode the cached instructions from instruction cache 102 to obtain the operation type and logical address or addresses associated with the operation type of each cached instruction. Instruction queues 104 are used to store the decoded instructions and real addresses. The decoded instructions are then dispatched by instruction dispatch unit 105 from instruction queues 104 to execution units 106 for execution. Execution units 106 are configured to perform the function or operation of an instruction taken from instruction queues 104.

According to one embodiment, instruction fetch unit 101 includes a low granularity selection unit 108, a high granularity selection unit 109, and fetch logic 110. The low granularity selection unit 108 is configured to select a thread (e.g., a candidate thread in the current fetch cycle) from each of first groups of threads, according to thread based low granularity selection scheme, forming a second group of threads. The high granularity selection unit 109 is configured to select one thread (e.g., a winning thread for the current fetch cycle) out of the second group of threads according to a thread group based high granularity selection scheme. Thereafter, an instruction of the selected thread by the high granularity selection unit 109 is fetched from memory 107 by fetch logic 110. According to the thread group based high granularity selection scheme, in one embodiment, instructions are fetched from each group in a round robin fashion. Instructions of multiple threads within a thread group are fetched according to a low granularity selection scheme, such as, for example, selecting a different thread within the same group.

In one embodiment, the output from instruction decoder 103 is monitored to detect any instruction (e.g., an instruction of a previous fetch cycle) of a thread that may potentially cause execution stall. If such an instruction is detected, a thread switch event is triggered and instruction fetch unit 101 is notified to fetch a next instruction from another thread of the same thread group. That is, instructions of intra-group threads are fetched using a low granularity selection scheme, which is based on an activity of another pipeline stage (e.g., decoding stage), while instructions of inter-group threads are fetched using a high granularity selection scheme.

In one embodiment, the instruction fetch stage uses a high-granularity selection scheme, for example, a round-robin arbitration algorithm. In every cycle, the instruction cache 102 is read to generate instructions for a different thread group. The instruction fetch rotates evenly among all of the thread groups in the processor, regardless of the state of that thread group. For a processor with T thread groups, this means that a given thread group will have access to the instruction cache one out of every T cycles, and there are also T cycles between one fetch and the next possible fetch within the thread group. The low-granularity thread switching events used to determine thread switching within a thread group can be detected within these T cycles in order to see no switching penalty when the switches are performed.

After instructions are fetched, they are placed in instruction cache 102. The output of the instruction cache 102 goes through instruction decoder 103 and instruction queues 104. The register file (not shown) is then accessed using the output of the decoder 103 to provide the operands for that instruction. The register file output is passed to operand bypass logic (not shown), where the final value for the operand is selected. The instruction queue 104, instruction decoder 103, register files, and bypass logic are shared by all of the threads in a thread group. The number of register file entries is scaled by the number of threads in the thread group, but the ports, address decoder, and other overhead associated with the memory are shared. When an instruction and all of its operands are ready, the instruction is presented to the execution unit arbiters (e.g., as part of instruction dispatch unit 105).

For the execution pipeline stage, the microprocessor 100 contains some number of execution units 106 which perform the operations required by the instructions. Each of these execution units are shared among some number of the thread groups. Each execution unit will also be associated with an execution unit arbiter which chooses an instruction from the instruction queue/register file blocks associated with the thread groups that share the execution unit in every clock cycle.

Each arbiter may pick up to one instruction from one of the thread groups to issue to its execution unit. In this way, the execution units use the high granularity multi-threading technique to arbitrate for their execution bandwidth. The execution units can include integer arithmetic logical units (ALUs), branch execution units, floating-point or other complex computational units, caches and local storage, and the path to external memory. The optimal number and functionality of the execution units are dependent upon the number of thread groups, the amount of latency seen by the threads (including memory latency, but also any temporary resource conflicts, and branch mispredictions), and the mix of instructions seen in the workloads of the threads.

With these mechanisms, a thread group effectively uses event-based, low granularity thread switching to arbitrate among its threads. This allows the stall conditions for the thread group to be minimized in the presence of long latency events in the individual threads. Among the thread groups, the processor uses the higher performing high-granularity technique to share the most critical global resources (e.g., instruction fetch bandwidth, execution bandwidth, and memory bandwidth).

One of the advantages of embodiments of the invention is that by using multiple techniques of arbitrating or selecting among multiple threads for shared resources, a processor with a large number of threads can be implemented in a manner that maximizes the ratio of processor performance to hardware cost. Additionally, the configuration of the thread groups and shared resources, especially the execution units, can be varied to optimize for the workload being executed, and the latency seen by the threads from requests to the rest of the system. The optimal configuration for the processor is both system and workload specific. The optimal number of threads in the processor is primarily dependent upon the ratio of the total amount of memory latency seen by the threads and the amount of execution bandwidth that they require. However, it becomes difficult to scale the threads up to this optimal number in large multi-processor systems where latency is high. The two main factors which make the thread scaling difficult are: 1) a large ratio of dedicated resource cost to shared resource cost, and 2) difficulty in performing monolithic arbitration among a large amount of threads in an efficient manner. The hierarchical threading described herein fixes both of these issues. Using the low-granularity arbitration or selection method allows the thread groups to have a large amount of shared resources while the high granularity arbitration or selection method allows the execution units to be used efficiently, which leads to a higher performance. For example, a processor with T thread groups, each containing N threads, the processor will contain (T×N) threads, but a single arbitration point will never have more than MAX (T, N) requestors.

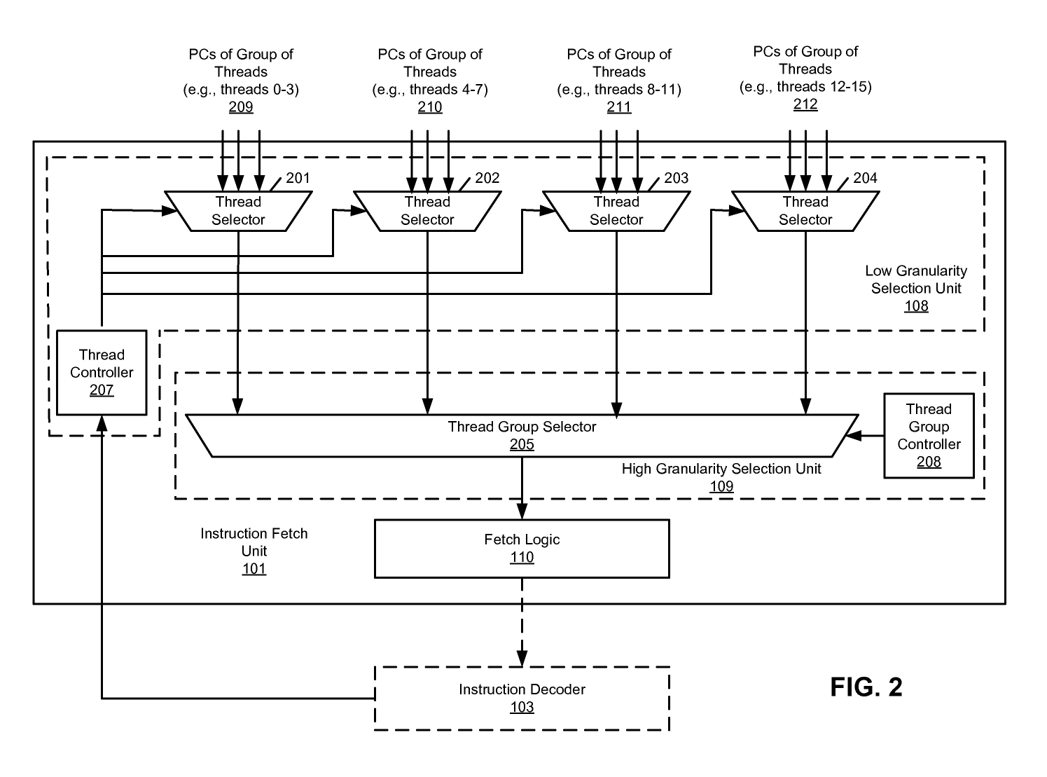

FIG. 2 is a block diagram illustrating a fetch pipeline stage of a processor according to one embodiment. For example, pipeline stage 200 may be implemented as a part of processor 100 of FIG. 1. For the purpose of illustration, reference numbers of certain components having identical or similar functionalities with respect to those shown in FIG. 1 are maintained the same. Referring to FIG. 2, in one embodiment, pipeline stage 200 includes, but not limited to, instruction fetch unit 101 and instruction decoder 103 having functionalities identical or similar to those as described above with respect to FIG. 1.

In one embodiment, instruction fetch unit 101 includes low granularity selection unit 108 and high granularity selection unit 109. Low granularity selection unit 108 includes one or more thread selectors 201-204 controlled by thread controller 207, each corresponding to a group of one or more threads. High granularity selection unit 109 includes a thread group selector 205 controlled by thread group controller 208. The output of each of the thread selectors 201-204 are fed to an input of a thread group selector 205. Note that for purpose of illustration, four groups of threads, each having four threads, are described herein. It will be appreciated that more or fewer groups or threads in each group may also be applied.

In one embodiment, each of the thread selectors 201-204 is configured to select one of one or more threads of the respective group based on a control signal or selection signal received from thread controller 207. Specifically, based on the control signal of thread controller 207, each of the thread selectors 201-204 is configured to select a program counter (PC) of one thread. Typically, a program counter is assigned to each thread, and the count value generated thereby provides the address for the next instruction or group of instructions to fetch in the associated thread for execution.

In one embodiment, based on information fed back from the output of instruction decoder 103, thread controller 207 is configured to select a program address of a thread for each group of threads associated with each of the thread selectors 201-204. For example, if it is determined that an instruction of a first thread (e.g., thread 0 of group 0 associated with thread selector 201) may potentially cause execution stall conditions, a feedback signal is provided to thread controller 207. For example, certain instructions such as memory access instructions (e.g., memory load instructions) or complex instructions (e.g., floating point divide instructions), or branch instructions may potentially cause execution stalls. Based on the feedback information (from a different pipeline stage, in this example, instruction decoding and queuing stage), thread controller 207 is configured to switch the first thread to a second thread (e.g., thread 1 of group 0 associated with thread selector 201) by selecting the appropriate program counter associated with the second thread.

For example, according to one embodiment, controller 207 receives a signal from each decoded instruction that may potentially cause execution stall conditions. In response, controller 207 determines the thread to which the decoded instruction belongs (e.g., type of instruction, instruction identifier, etc.) and identifies a group the identified thread belongs. Controller 207 then assigns or selects a program counter of another thread via the corresponding thread selector, which in effect switches from a current thread to another thread of the same group. The feedback to the thread controller that indicates that is should switch threads can also come from later in the pipeline, and could then include more dynamic information such as data cache misses.

Outputs (e.g., program addresses of corresponding program counters) of thread selectors 201-204 are coupled to inputs of a thread group selector 205, which is controlled by thread group controller 208. Thread group controller 208 is configured to select one of the groups associated with thread selectors 201-204 as a final fetch address (e.g., winning thread of the current fetch cycle) using a high granularity arbitration or selection scheme. In one embodiment, thread group controller 208 is configured to select in a round robin fashion, regardless the states of the thread groups. This selection could be made more opportunistically by detecting which threads are unable to perform instruction fetch at the current time (because of an instruction cache or Icache miss or branch misprediction, for example) and remove those threads from the arbitration. The final fetch address is used by fetch logic 206 to fetch a next instruction for queuing and/or execution.

In one embodiment, thread selectors 201-204 and/or thread group selector 205 may be implemented using multiplexers. However, other types of logics may also be utilized. In one embodiment, thread controller 207 may be implemented in a form of demultiplexer.

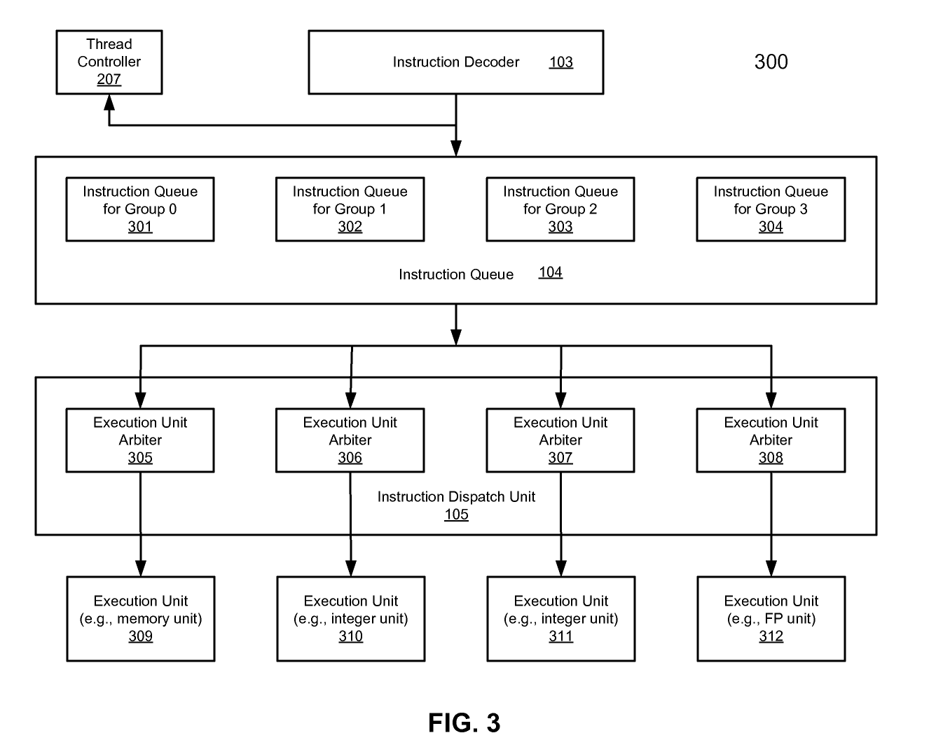

FIG. 3 is a block diagram illustrating an execution pipeline stage of a processor according to one embodiment of the invention. For example, pipeline stage 300 may be implemented as a part of processor 100 of FIG. 1. For the purpose of illustration, reference numbers of certain components having identical or similar functionalities with respect to those shown in FIG. 1 are maintained the same. Referring to FIG. 3, in one embodiment, pipeline stage 300 includes instruction decoder 103, instruction queue 104, instruction dispatch unit 105, and execution units 309-312 which may be implemented as part of execution units 106. The output of instruction decoder 103 is coupled to thread controller or logic 207 and instructions decoded by instruction decoder 103 are monitored. A feedback is provided to thread controller 207 if there is an instruction detected that may potentially cause execution stall conditions for the purposes of fetching next instructions as described above.

In one embodiment, instruction queue unit 104 includes one or more instruction queues 301-304, each corresponding to a group of threads. Again, for the purpose of illustration, it is assumed there are four groups of threads. Also, for the purpose of illustration, there are four execution units 309-312 herein, which may be an integer unit, a floating point unit (e.g., complex execution unit), a memory unit, a load/store unit, etc. Instruction dispatch unit 105 includes one or more execution unit arbiters (also simply referred to as arbiters), each corresponding to one of the execution units 309-312. An arbiter is configured to dispatch an instruction from any one of instruction queues 301-304 to the corresponding execution unit, dependent upon the type of the instruction and the availability of the corresponding execution unit. Other configurations may also exist.

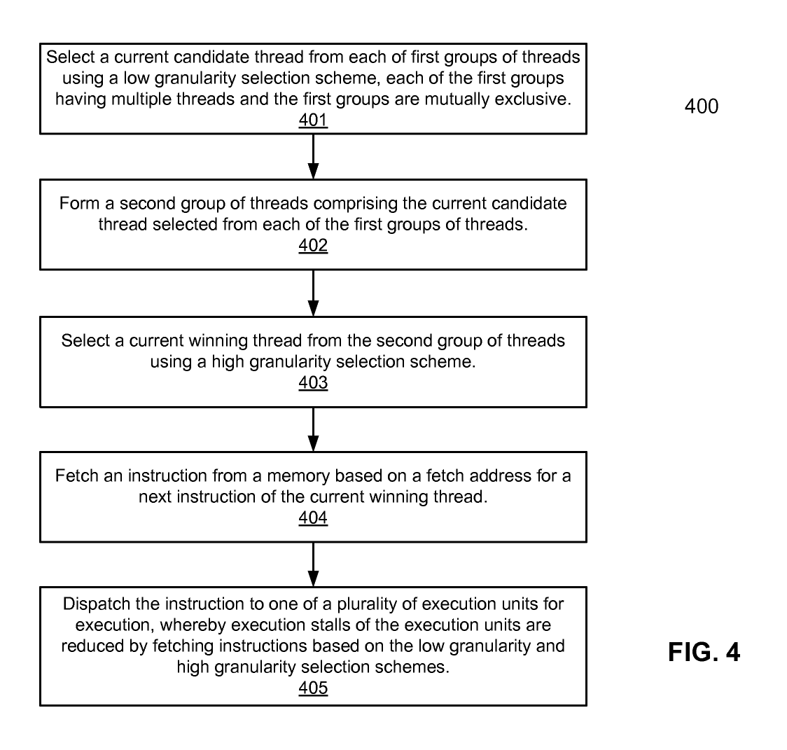

FIG. 4 is a flow diagram illustrating a method for fetching instructions according to one embodiment of the invention. Note that method 400 may be performed by processing logic which may include hardware, firmware, software, or a combination thereof. For example, method 400 may be performed by processor 100 of FIG. 1. Referring to FIG. 4, at block 401, a current candidate thread is selected from each of multiple first groups of threads using a low granularity arbitration scheme. Each of the first groups includes multiple threads. The first groups of threads are mutually exclusive. At block 402, a second group of threads is formed based on the current candidate thread selected from each of the first groups of threads. At block 403, a current winning thread is selected from the second group of thread using a high granularity selection or arbitration scheme. At block 404, an instruction is fetched from a memory based on a fetch address for a next instruction of the winning thread. In one embodiment, the fetch address may be obtained from the corresponding program counter of the selected one thread. At block 405, the fetched instruction is dispatched to one of the execution units for execution. As a result, the execution stalls of the execution units can be reduced by fetching instructions based on the low granularity selection scheme and high granularity selection scheme.

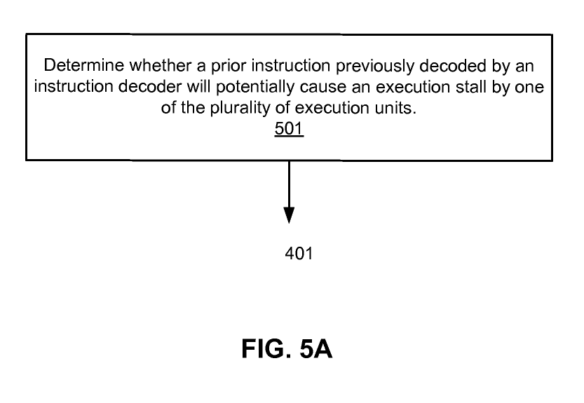

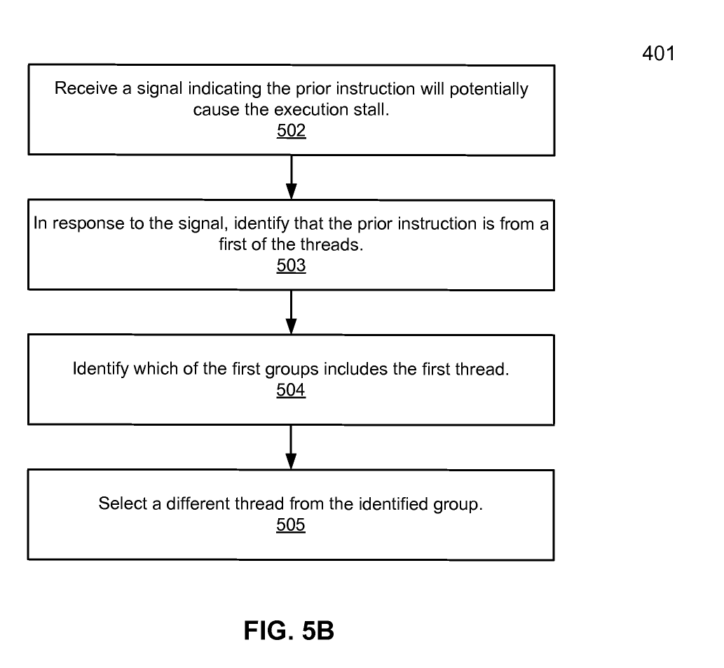

FIG. 5A is a flow diagram illustrating a method for fetching instructions according to another embodiment of the invention. Referring to FIG. 5A, at block 501, it is determined whether a prior instruction previously decoded by an instruction decoder will potentially cause an execution stall by an execution unit. Such detection may trigger the thread switching event performed in FIG. 1.

FIG. 5B is a flow diagram illustrating a method for fetching instructions according to another embodiment of the invention. Note that the method as shown in FIG. 5B may be performed as part of block 401 of FIG. 4. Referring to FIG. 5B, at block 502, a signal is received indicating that a prior instruction will potentially cause the execution stall. Such a signal may be received from monitoring logic that monitors the output of the instruction decoder. In response to the signal, at block 503, processing logic identifies that the prior instruction is from a first thread. At block 504, processing logic identifies a group from multiple groups of threads that includes the first thread. At block 505, a different thread is selected from the identified group.

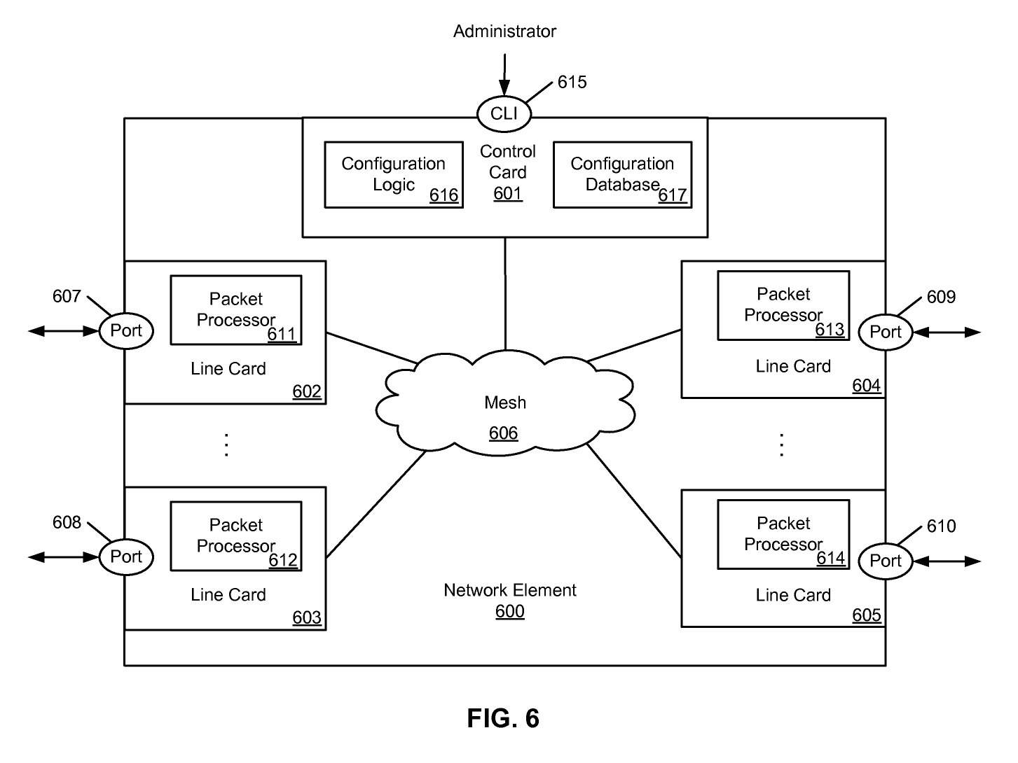

FIG. 6 is a block diagram illustrating a network element according to one embodiment of the invention. Network element 600 may be implemented as any network element having a packet processor as shown in FIG. 1. Referring to FIG. 6, network element 600 includes, but is not limited to, a control card 601 (also referred to as a control plane) communicatively coupled to one or more line cards 602-605 (also referred to as interface cards or user planes) over a mesh 606, which may be a mesh network, an interconnect, a bus, or a combination thereof. A line card is also referred to as a data plane (sometimes referred to as a forwarding plane or a media plane). Each of the line cards 602-605 is associated with one or more interfaces (also referred to as ports), such as interfaces 607-610 respectively. Each line card includes a packet processor, routing functional block or logic (e.g., blocks 611-614) to route and/or forward packets via the corresponding interface according to a configuration (e.g., routing table) configured by control card 601, which may be configured by an administrator via an interface 615 (e.g., a command line interface or CLI). According to one embodiment, control card 601 includes, but is not limited to, configuration logic 616 and database 617 for storing information configured by configuration logic 616.

In one embodiment, each of the processors 611-614 may be implemented as a part of processor 100 of FIG. 1. At least one of the processors 611-614 may employ a combination of high granularity selection scheme and low granularity selection scheme as described throughout this application.

Referring back to FIG. 6, in the case that network element 600 is a router (or is implementing routing functionality), control plane 601 typically determines how data (e.g., packets) is to be routed (e.g., the next hop for the data and the outgoing port for that data), and the data plane (e.g., lines cards 602-603) is in charge of forwarding that data. For example, control plane 601 typically includes one or more routing protocols (e.g., Border Gateway Protocol (BGP), Interior Gateway Protocol(s) (IGP) (e.g., Open Shortest Path First (OSPF), Routing Information Protocol (RIP), Intermediate System to Intermediate System (IS-IS), etc.), Label Distribution Protocol (LDP), Resource Reservation Protocol (RSVP), etc.) that communicate with other network elements to exchange routes and select those routes based on one or more routing metrics.

Routes and adjacencies are stored in one or more routing structures (e.g., Routing Information Base (RIB), Label Information Base (LIB), one or more adjacency structures, etc.) on the control plane (e.g., database 608). Control plane 601 programs the data plane (e.g., line cards 602-603) with information (e.g., adjacency and route information) based on the routing structure(s). For example, control plane 601 programs the adjacency and route information into one or more forwarding structures (e.g., Forwarding Information Base (FIB), Label Forwarding Information Base (LFIB), and one or more adjacency structures) on the data plane. The data plane uses these forwarding and adjacency structures when forwarding traffic.

Each of the routing protocols downloads route entries to a main routing information base (RIB) based on certain route metrics (the metrics can be different for different routing protocols). Each of the routing protocols can store the route entries, including the route entries which are not downloaded to the main RIB, in a local RIB (e.g., an OSPF local RIB). A RIB module that manages the main RIB selects routes from the routes downloaded by the routing protocols (based on a set of metrics) and downloads those selected routes (sometimes referred to as active route entries) to the data plane. The RIB module can also cause routes to be redistributed between routing protocols. For layer 2 forwarding, the network element 600 can store one or more bridging tables that are used to forward data based on the layer 2 information in this data.

Typically, a network element may include a set of one or more line cards, a set of one or more control cards, and optionally a set of one or more service cards (sometimes referred to as resource cards). These cards are coupled together through one or more mechanisms (e.g., a first full mesh coupling the line cards and a second full mesh coupling all of the cards). The set of line cards make up the data plane, while the set of control cards provide the control plane and exchange packets with external network element through the line cards. The set of service cards can provide specialized processing (e.g., Layer 4 to Layer 7 services (e.g., firewall, IPsec, IDS, P2P), VoIP Session Border Controller, Mobile Wireless Gateways (GGSN, Evolved Packet System (EPS) Gateway), etc.). By way of example, a service card may be used to terminate IPsec tunnels and execute the attendant authentication and encryption algorithms. As used herein, a network element (e.g., a router, switch, bridge, etc.) is a piece of networking equipment, including hardware and software, that communicatively interconnects other equipment on the network (e.g., other network elements, end stations, etc.). Some network elements are “multiple services network elements” that provide support for multiple networking functions (e.g., routing, bridging, switching, Layer 2 aggregation, session border control, Quality of Service, and/or subscriber management), and/or provide support for multiple application services (e.g., data, voice, and video).

Subscriber end stations (e.g., servers, workstations, laptops, palm tops, mobile phones, smart phones, multimedia phones, Voice Over Internet Protocol (VOIP) phones, portable media players, global positioning system (GPS) units, gaming systems, set-top boxes, etc.) access content/services provided over the Internet and/or content/services provided on virtual private networks (VPNs) overlaid on the Internet. The content and/or services are typically provided by one or more end stations (e.g., server end stations) belonging to a service or content provider or end stations participating in a peer to peer service, and may include public Web pages (free content, store fronts, search services, etc.), private Web pages (e.g., username/password accessed Web pages providing email services, etc.), corporate networks over VPNs, etc. Typically, subscriber end stations are coupled (e.g., through customer premise equipment coupled to an access network (wired or wirelessly)) to edge network elements, which are coupled (e.g., through one or more core network elements) to other edge network elements, which are coupled to other end stations (e.g., server end stations).

Note that network element 600 is described for the purpose of illustration only. More or fewer components may be implemented dependent upon a specific application. For example, although a single control card is shown, multiple control cards may be implemented, for example, for the purpose of redundancy. Similarly, multiple line cards may also be implemented on each of the ingress and egress interfaces. Also note that some or all of the components as shown in FIG. 6 may be implemented in hardware, software, or a combination of both.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method performed by a processor for fetching and dispatching instructions from multiple threads, the method comprising the steps of:
selecting a current candidate thread from each of a plurality of first groups of threads using a low granularity selection scheme, each of the first groups having a plurality of threads, wherein the plurality of first groups are mutually exclusive;
forming a second group of threads comprising the current candidate thread selected from each of the first groups of threads;
selecting a current winning thread from the second group of threads using a high granularity selection scheme;
fetching an instruction from a memory based on a fetch address for a next instruction of the current winning thread; and,
dispatching the instruction to one of a plurality of execution units for execution, whereby execution stalls of the execution units are reduced by fetching instructions based on the low granularity and high granularity selection schemes.

2. The method of claim 1, further comprising determining whether a prior instruction previously decoded by an instruction decoder will potentially cause an execution stall by one of the plurality of execution units, wherein the step of selecting the current candidate thread from each of the first groups is performed based on the step of determining whether the prior instruction will potentially cause the execution stall.

3. The method of claim 2, wherein the step of determining is performed based on at least one of a type of the prior instruction and a type of execution unit required to execute the prior instruction.

4. The method of claim 3, wherein the type of instruction that potentially causes execution stalls includes at least one of a memory load instruction, a memory save instruction, and a floating point instruction.

5. The method of claim 3, wherein the type of execution unit that potentially causes execution stalls includes at least one of a memory execution unit and a floating point execution unit.

6. The method of claim 2, wherein the low granularity selection scheme comprises:
receiving a signal indicating the prior instruction will potentially cause the execution stall;
in response to the signal, identifying that the prior instruction is from a first of the threads;
identifying which of the first groups includes the first thread; and
selecting a different thread from the identified group.

7. The method of claim 1, wherein the high granularity selection scheme comprises selecting the current winning thread from the second group of threads in a round robin fashion.

8. The method of claim 2, further comprising:
distributing instructions from the instruction decoder to a plurality of instruction queues, each corresponding to one of the first groups of threads; and
assigning instructions selected from the instruction queues to the execution units.

9. The method of claim 8, wherein the step of assigning includes selecting from the instruction queues based on an instruction type of the one of the instructions currently being assigned and availability of one of the execution units that can execute the instruction type.

10. A processor, comprising:
a plurality of execution units;
an instruction fetch unit including
a low granularity selection unit adapted to select a current candidate thread from each of a current plurality of first groups of threads using a low granularity selection scheme, each of the current first groups having a plurality of threads, wherein the plurality of first groups are mutually exclusive, and wherein the currently selected candidate threads from the current first groups form a current second group of threads,
a high granularity selection unit adapted to select as a currently winning thread one of the threads from the current second group of threads using a high granularity selection scheme,
a fetch logic adapted to fetch a next instruction from a memory from the currently winning thread; and
an instruction dispatch unit adapted to dispatch to the execution units for execution operations specified by the fetched instructions, whereby execution stalls of the execution units are reduced by fetching instructions based on the low granularity and high granularity selection schemes.

11. The processor of claim 10, wherein the low granularity selection unit comprises:
a plurality of thread selectors, each corresponding to one of the current first groups of threads; and
a thread controller coupled to each of the plurality of thread selectors, wherein the thread controller is adapted to control each of the thread selectors to select the current candidate thread from the corresponding first group of threads to form the current second group of threads.

12. The processor of claim 11, wherein the high granularity selection unit comprises:
a thread group selector coupled to outputs of the thread selectors; and
a thread group controller coupled to the thread group selector, wherein the thread group controller is adapted to control the thread group selector to select the current winning thread from the current second group of threads.

13. The processor of claim 10, further comprising:
an instruction cache adapted to buffer the fetched instructions received from the fetch logic; and
an instruction decoder adapted to decode the fetched instructions received from the instruction cache, wherein the thread controller is adapted to determine whether each of the decoded instructions will potentially cause an execution stall by one of the execution units, wherein the selection of the current candidate threads from each of the current plurality of first groups of threads is performed based on the determinations.

14. The processor of claim 13, wherein determination of whether an instruction potentially causes an execution stall is performed based on at least one of a type of the instruction and a type of an execution unit required to execute the instruction.

15. The processor of claim 13, wherein the low granularity selection unit is further adapted to
receive signals indicating which of the decoded instructions will potentially cause execution stalls,
in response to the signals, identify which of the threads include the instructions that will potentially causes execution stalls,
identify which of the current first groups includes the identified threads, and
select different threads within the identified first groups as the current candidate threads.

16. The processor of claim 13, wherein the high granularity selection unit is adapted to select the currently winning thread from the current second group of threads in a round robin fashion.

17. The processor of claim 11, further comprising:
a plurality of instruction queues, each corresponding to one of the first groups of threads, adapted to receive instructions from the instruction decoder,
wherein the instruction dispatch unit comprises a plurality of arbiters, each corresponding one of the execution units, adapted to assign instructions currently selected from the instruction queues to the execution units.

18. The processor of claim 17, wherein the instructions currently selected from the instruction queues are selected based on a type of the instructions and availability of execution units that can execute those types.
